(19) United States
(12) Patent Application Publication
(10) Pub. No.: US 2003/0094408 A1
(43) Pub. Date: May 22, 2003

(54) Length-adjustable filter cartridges

(76) Inventors: Charles C. Schuyler, Baltimore, MD (US); Charles S. Hoffman, Baltimore, MD (US); Norman F. Robillard, Sparks, MD (US)

Correspondence Address: NIXON & VANDERHYE P.C., 8th Floor, 1100 North Glebe Road, Arlington, VA, 22201, US

(21) Appl. No.: 09/988,222

(22) Filed: Nov. 19, 2001

(51) Int. Cl. B01D 27/06

(52) U.S. Cl. 210/232; 210/450; 210/455; 210/438; 210/452; 210/493.2

(57) ABSTRACT

Length-adjustable filter cartridges are provided which in preferred embodiments include at least one length-adjustable end cap attached to an end of a generally cylindrical filter body. The length-adjustable end cap most preferably includes an annular stationary ring member which is attached to one end of the filter body, and a moveable connection member slideably received within said annular stationary ring member so as to be moveable longitudinally relative thereto. A seal is formed between the stationary ring member and the moveable connection member so as to seal against fluid leakage yet permit relative axial movement (length adjustment) therebetween. In use, the filter cartridges may be adapted to fit conventional standardized bag filter cartridge housings even though the physical size and/or geometries of the metal support basket thereof is non-standard. That is, a filter cartridge having the length-adjustable end cap of the present invention may be positioned within a standard sized bag filter cartridge housing, whereby the length-adjustable end cap may be longitudinally moved until the filter cartridge length corresponds substantially to that of the surrounding metal support basket in which it is placed. As such, the bottom end cap of the filter cartridge is ensured to be supported by the metal basket to prevent it from rupturing during normal use.

### FIELD OF THE INVENTION

The present invention relates generally to the field of filter cartridges. More particularly, the present invention relates to filter cartridges which are length-adjustable.

### BACKGROUND AND SUMMARY OF THE INVENTION

Manufacturers of industrial disposable rigid filter cartridges have for many years essentially standardized filter cartridge diameter and length dimensions and geometries. As a result, the filter cartridges produced by virtually every manufacturer is capable of being employed in another manufacturer's cartridge housing. Nonetheless, there still exists a need for non-standardized filter cartridges to be provided to the industry. For example, the standardized filter cartridge geometry may not be entirely sufficient for use in large filtration installations and/or to filter heavily contaminated fluids. While higher capacity filter cartridge geometries can be envisioned, their commercial acceptance is limited due to the costs associated with the replacement of existing filter cartridge housings designed for use with the conventional standardized filter cartridge geometries.

Bag filters have, to some extent, solved some of the issues presented by filter cartridges with respect to more rigid filter cartridges. In this regard, a bag filter is essentially a closed-end pouch made of a filter material (e.g., a felt or nonwoven material). The bags are installed in perforated rigid metal baskets which serve to support the bag against the inlet pressure of the fluid to be filtered. In this regard, the bag filters are positioned such that the fluid flows into the open top of the bag and then through the bag wall (i.e., an inside-out flow path) and the outer supporting metal basket. Some advantages of employing bag filters is that the bags offer ease of installation and all the contaminant is trapped inside the bag allowing for ease of disposal. Disadvantages of bag filters include their relatively low surface area and limited types of filter media (e.g., most commercial bag filters are formed of a needle punched felt material).

Most forms of conventional rigid metal baskets in which bag filters are employed include an open top having a seal flange for dependently supporting the bag filter, a generally cylindrical perforated side wall portion and a conical or rounded bottom wall region. The seal flange is essentially standardized among bag filter manufactures, but the axial length of the side wall portion varies from one manufacturer to another. Since the fluid flow though conventional bag filter systems is inside-out, any commercially successful more rigid disposable filter cartridge that is provided as a high filter capacity replacement for conventional bag filters must have its bottom supported physically by the surrounding perforated side wall of the metal basket. However, since the effective axial length of the cylindrical perforated side wall can, and often does, vary from one manufacturer to the next, no currently available cartridge design can universally be supplied to the entire market.

Therefore, what has been needed in this art are filter cartridges that are suitable for use with standardized bag filter housings (more particularly, with the varying length support baskets thereof), yet be capable of providing enhanced fluid filtration capabilities as compared to conventional bag filters. The present invention is directed towards fulfilling such needs.

Broadly, the present invention is embodied in length-adjustable filter cartridges. In especially preferred forms, the present invention is embodied in filter cartridges having a generally cylindrical filter body which includes a fluid-filtration media, and at least one length-adjustable end cap attached to an end of the filter body. The length-adjustable end cap most preferably includes an annular stationary ring member which is attached to one end of the filter body, and a moveable connection member slideably received within said annular stationary ring member so as to be moveable longitudinally relative thereto. A seal is formed between the stationary ring member and the moveable connection member so as to seal against fluid leakage yet permit relative axial movement (length adjustment) therebetween.

In use, the filter cartridges of the present invention may be adapted to fit conventional standardized bag filter cartridge housings even though the physical size and/or geometries of the metal support basket thereof is non-standard. That is, a filter cartridge having the length-adjustable end cap of the present invention may be positioned within a standard sized bag filter cartridge housing, whereby the length-adjustable end cap may be longitudinally moved until the filter cartridge length corresponds substantially to that of the surrounding metal support basket in which it is placed. As such, the bottom end cap of the filter cartridge is ensured to be supported by the metal basket to prevent it from rupturing during normal use.

These and other aspects and advantages will become more apparent after careful consideration is given to the following detailed description of the preferred exemplary embodiments thereof.

### BRIEF DESCRIPTION OF THE ACCOMPANYING DRAWINGS

Reference will hereinafter be made to the accompanying drawings, wherein like reference numerals throughout the various FIGURES denote like structural elements, and wherein;

FIG. 1 is a cross-sectional view of a conventional bag filter housing system in which an exemplary length-adjustable filter cartridge in accordance with the present invention is positioned;

FIG. 2 is an elevational view of an exemplary length-adjustable filter cartridge embodying the present invention;

FIG. 3 is an enlarged cross-sectional view taken along line 8-8 in FIG. 1 which more specifically depicts the length-adjustable top end cap associated with the filter cartridge depicted in FIG. 8; and

FIG. 4 is an enlarged cross-sectional view of another top end cap that may be associated with another exemplary embodiment of the length-adjustable filter cartridge in accordance with the present invention;

FIG. 5 is a side elevational view of another exemplary embodiment of a length-adjustable filter cartridge in accordance with the present invention;

FIG. 6 is a top end perspective view thereof;

FIG. 7 is a bottom end perspective view thereof;

FIG. 8 is a cross-sectional elevational view of the filter cartridge depicted in FIG. 5, as taken along line 8-8 therein;

FIG. 9 is a schematic representation of the pressure conditions exerted on the top end cap of the filter cartridge embodiment depicted in FIGS. 5-8; and

FIG. 10 is an exemplary graphical plot which depicts the pressure conditions exerted on the top end cap of the filter cartridge embodiment depicted in FIGS. 1-5;

### DETAILED DESCRIPTION OF THE INVENTION

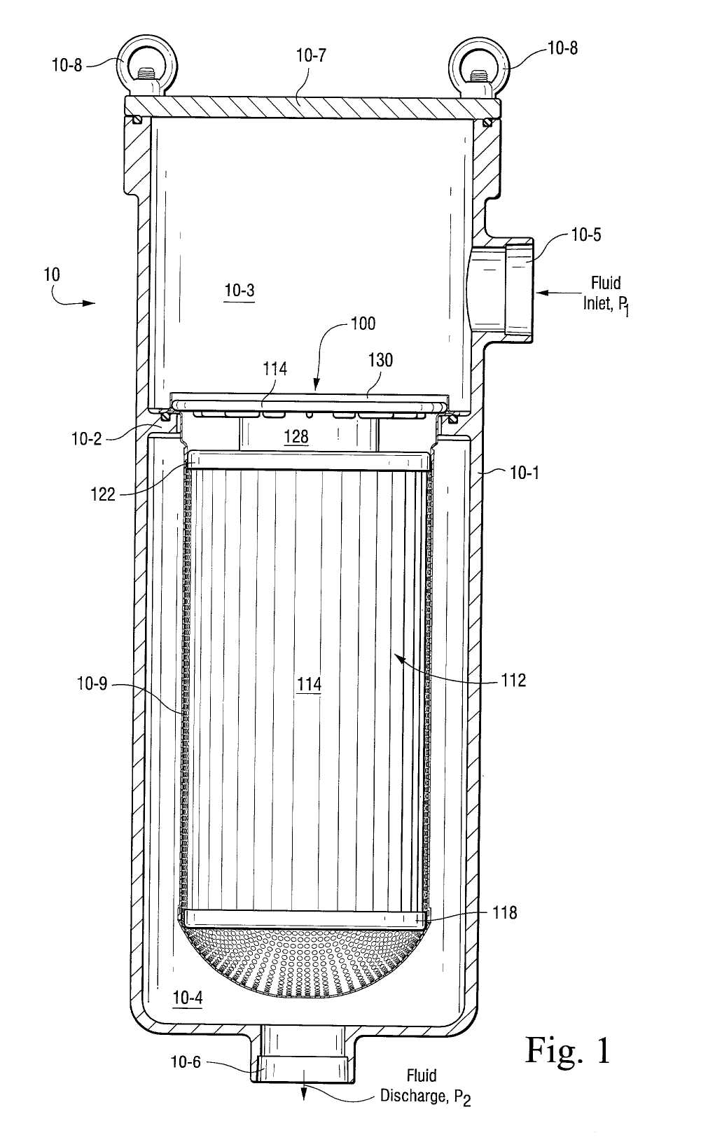

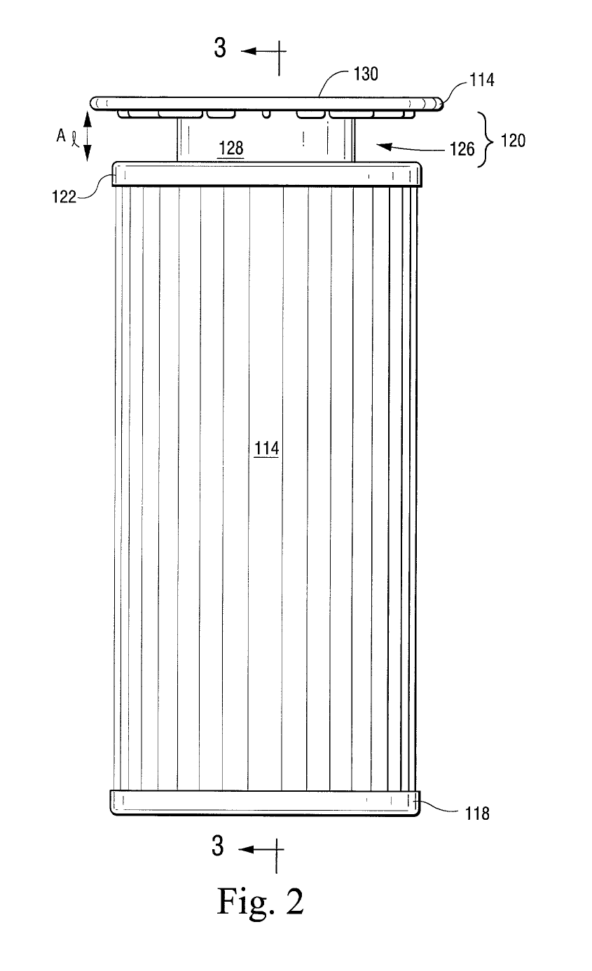

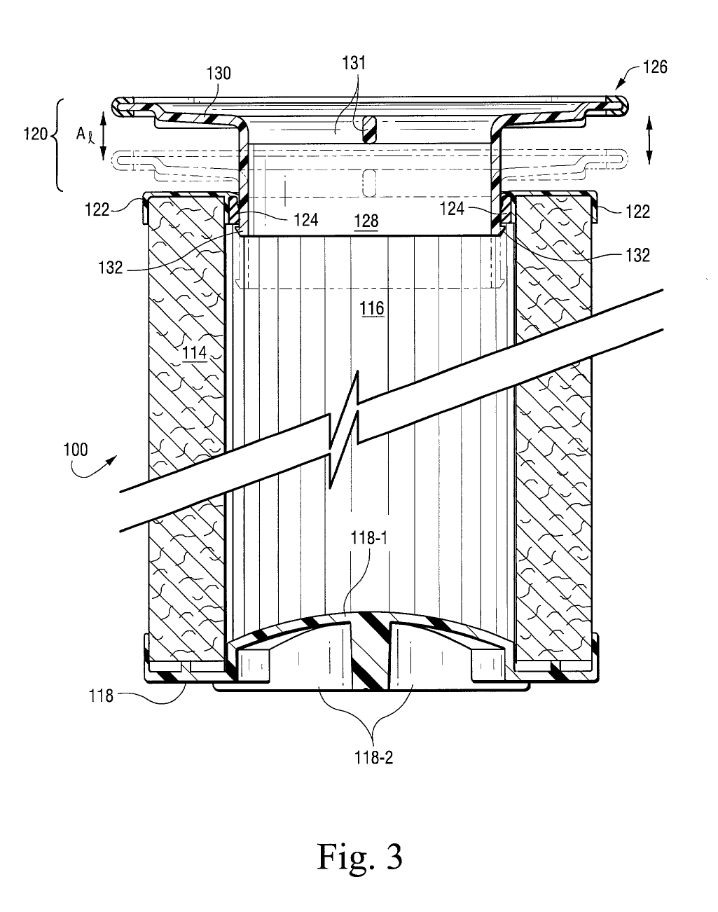

Accompanying FIG. 1 depicts a cross-sectional view of a conventional bag filter housing system 10 in which an exemplary length-adjustable filter cartridge 100 (see FIGS. 2-3, for example) in accordance with the present invention is positioned. In this regard, the housing system 10 includes a generally cylindrical housing wall 10-1 having an annular support flange 10-2 which establishes upper and lower interior chambers 10-3, 10-4, respectively. The upper and lower interior chambers 10-3, 10-4 communicate with inlet and discharge ports 10-5, 10-6, respectively. Fluid to be filtered will thus enter the housing 10 at a pressure P1 via the port 10-5, pass through the filter media of the filter cartridge 100 so as to remove particulate matter therefrom, and then be discharged from the housing 10 at a pressure P2 less than P1 via the port 10-6.

The top of the housing 10 is closed by a lid 10-7 by means of conventional swing bolt assemblies 10-8. Removal of the lid 10-7 will thus allow access to the interior of the housing 10 so that the filter cartridge 100 may be replaced periodically. It will be observed in this regard that the top annular seal 114 of the cartridge 100 is dependently supported by the annular support flange 10-2 of the housing 10. Also, it will be observed that the upper rim of the internal rigid perforated support basket 10-9 is dependently supported by the support flange 10-2 of the housing 10. Thus, since the inlet pressure P1 of the fluid entering the upper interior chamber 10-3 is greater than the discharge pressure P2 of the filtered fluid being discharged from the lower interior chamber 10-4, the seal 14 of the filter cartridge 121 will be pressed into sealing contact with the support flange 10-2 and the upper rim of the support basket 10-9 thereby preventing fluid leakage therearound.

Accompanying FIGS. 2 and 3 depict one preferred embodiment of a disposable filter cartridge 100 in accordance with the present invention. In this regard, the filter cartridge 100 is most preferably comprised of a generally cylindrical filter body 112 provided with suitable filter media 114 defining an interior space 116. A bottom end cap 118 is physically attached to (e.g., by heat-welding, adhesives, solvent bonding or like techniques) the filter media 114 at the lower end of the filter cartridge body 112 so as to close the interior space 116 at that end. A length-adjustable end cap assembly 120 is physically attached to the opposite end of the filter body 112 by similar means.

As is perhaps more clearly seen in FIG. 3, the bottom end cap 118 most preferably includes an arcuate central wall 118-1 which protrudes into the interior cartridge space 116 and a series of integral radial support ribs 20-2. The arcuate central wall 118-1 and support rigs 118-2 collectively serve to enhance the structural integrity of the filter cartridge body 112 at its lower end so that it may withstand the inlet pressures P1 associated with the inlet fluid entering the interior cartridge space 116.

The length-adjustable top end cap assembly 120 includes an annular stationary ring member 122 which is physically attached (e.g., by heat welding, adhesives, solvent bonding or like techniques) to the end surface of the filter media 114. A seal ring 124 is fixed to an inner annular region of the stationary ring member 122 so as to be coaxially positioned with respect to the inner space 116.

A moveable connection member 126 includes a lower cylindrical neck portion 128 and an upper annular flange portion 130. Most preferably, the neck and flange portions 128, 130 are formed as a unitary (one-piece) structure and provided with cross-supports 131 so as to increase the structural integrity of the same while yet retaining an opening which communicates with the interior space 116 of the filter cartridge 100. The neck portion 128 is received within, and is slideable with respect to, the annular stationary ring member 122 as shown by the arrows A_{I} in FIGS. 2 and 3 in sealing contact with the seal ring 124. Thus, the entire connection member 126 is slideable along the longitudinal axis of the filter cartridge 100 so that the flange portion 130 thereof may be moved towards and away from the stationary ring member 122 (i.e., as shown by the phantom lines in FIG. 3). During such sliding movement, however, a fluid seal is maintained between the exterior surface of the neck portion 126 and the seal ring 124.

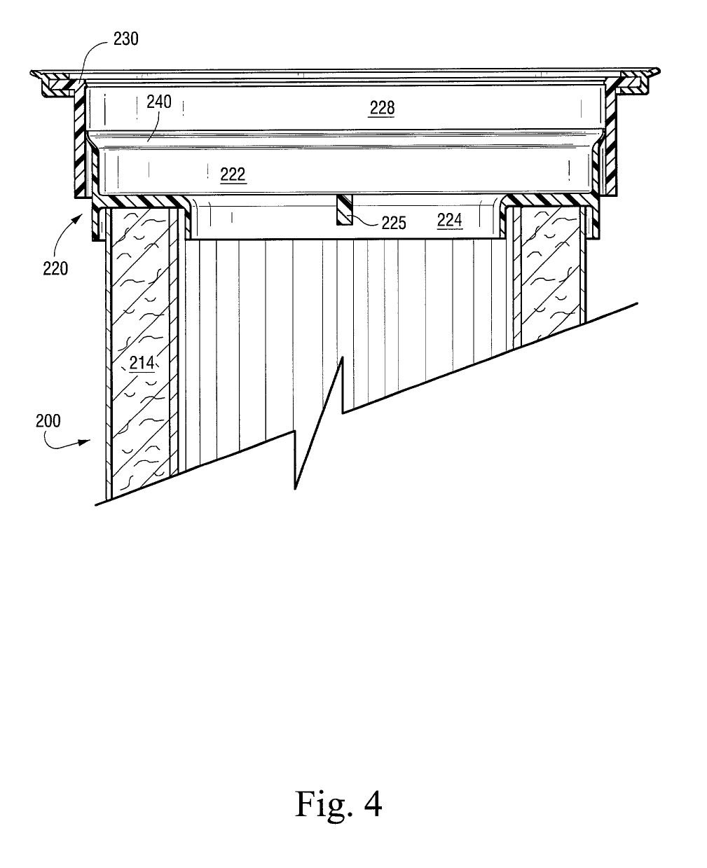

An annular stop surface 132 protruding radially outwardly from the terminal end of the neck portion 128 so as to provide limit to the movement of the moveable member 126 and thereby define a maximum separation distance between the flange portion 130 and the stationary ring member 122 (i.e., as shown by the solid lines in FIG. 3). Thus, upon contact between the annular stop surface 132 and the seal ring 124, a maximum longitudinal dimension of the filter cartridge 100 will ensue. Conversely, upon contact between the flange portion 130 and the stationary ring 122, a minimum longitudinal dimension of the filter cartridge will ensure. As a result, the embodiment of the filter cartridge 100 as shown in FIGS. 3 and 4 may be adapted to fit conventional support baskets 10-9 provided within typical bag filter housing systems 10 as described previously. That is, the filter cartridge 100 having the length-adjustable end cap 120 as described above, may be positioned within a perforated support basket 10-9 of a housing system 10, whereby the length-adjustable end cap may be longitudinally moved until the lower end cap 118 thereof is physically supported by the basket 10-9 in a manner described previously.

Yet another possible length-adjustable filter cartridge 200 is depicted in accompanying FIG. 4. In this regard, the filter cartridge assembly 200 is provided with a length adjustable top end cap assembly 220. The filter cartridge 200 may be provided with the same bottom end cap 118 as described previously with respect to FIGS. 2 and 3.

The top end cap assembly 220 most preferably includes a cylindrical stationary ring member 222 which extends upwardly from an annular base member 224. The base member 224 is itself physically attached (e.g., by heat welding, adhesives, solvent bonding or like techniques) to the end surface of the filter media 214. Integral cross-support rods 225 are provided so as to provide internal support for the base 224, yet allow essentially unimpeded fluid flow therethrough.

A moveable connection member 226 includes a lower cylindrical neck portion 228 and an upper annular flange portion 230. Most preferably, the neck and flange portions 228, 230 are formed as a unitary (one-piece) structure so as to increase the structural integrity of the same. The neck portion 228 is received within, and is slideable with respect to, the annular stationary ring member 222. In this regard, the upper lip 240 of the stationary ring 222 is outwardly biased so as to form a flexible fluid-tight seal with the neck portion 228.

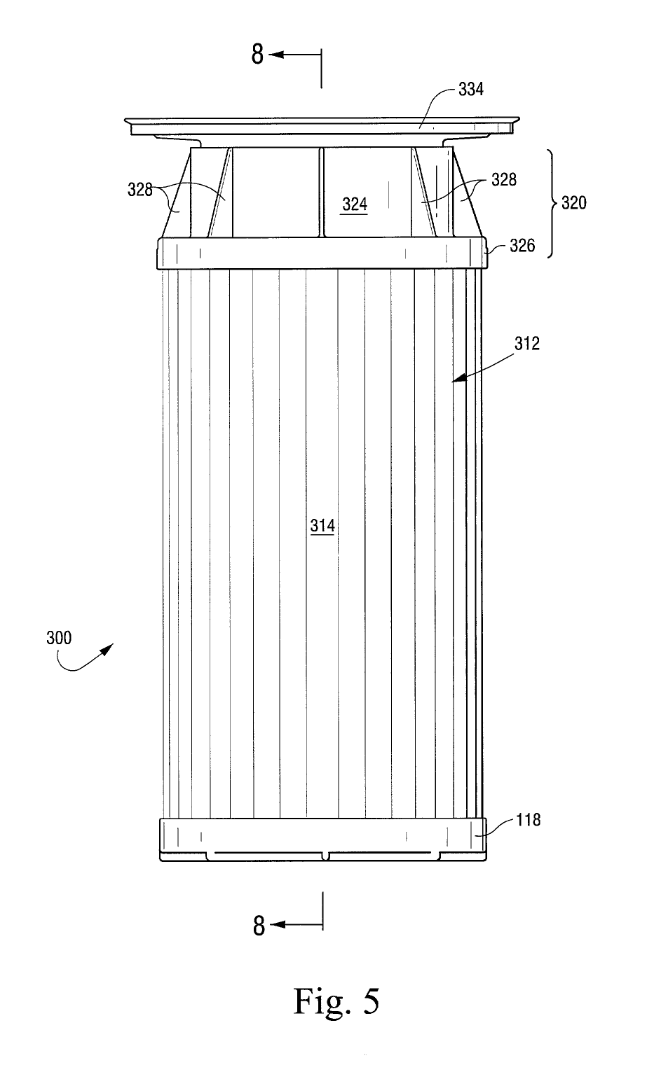

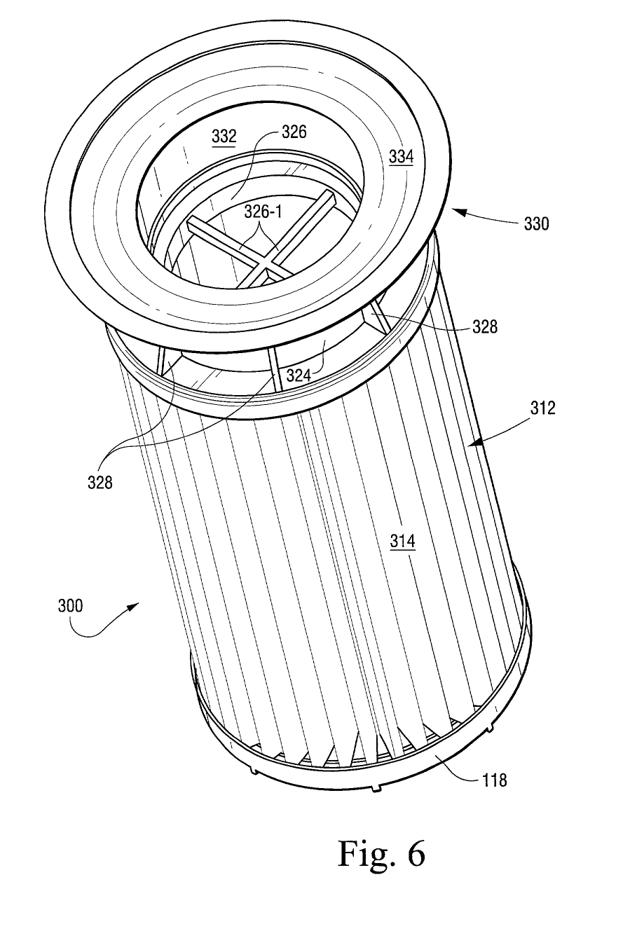

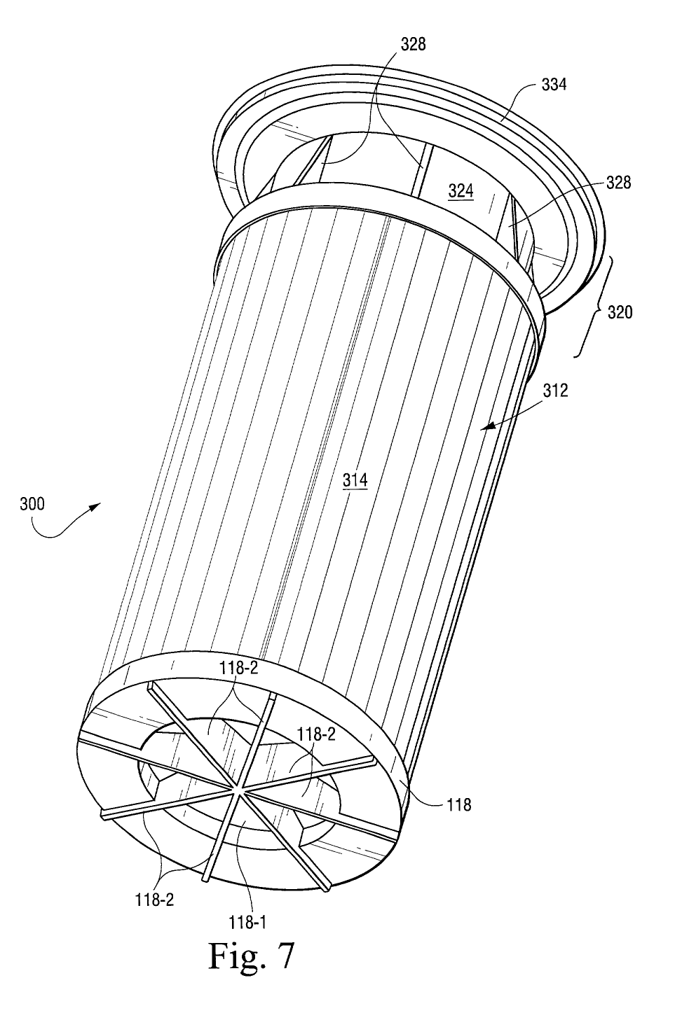

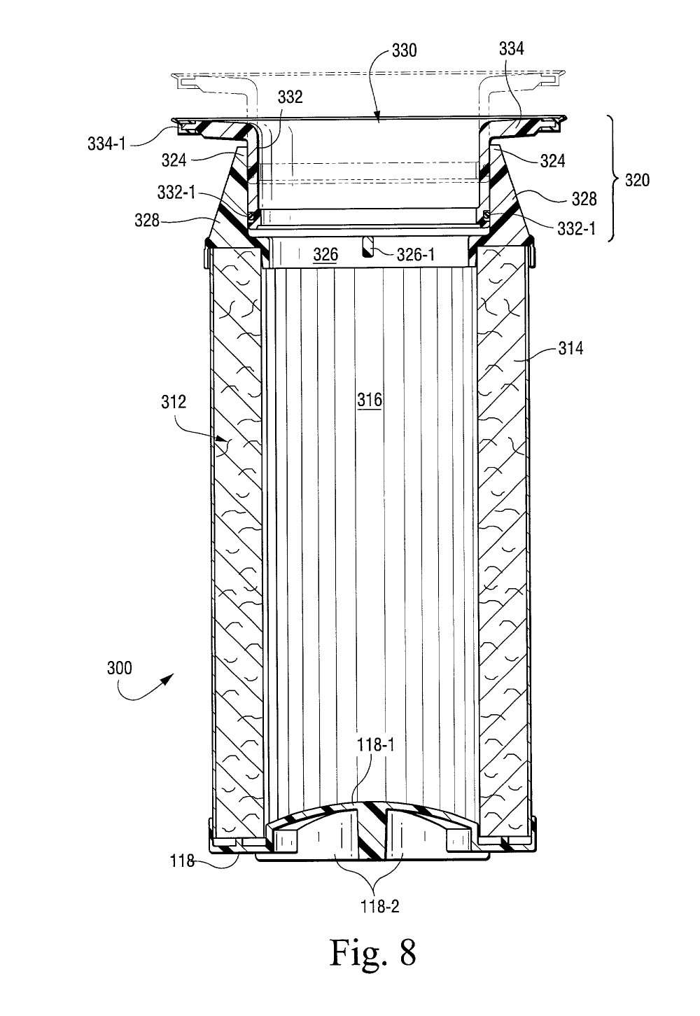

Accompanying FIGS. 5-8 depict another preferred embodiment of a length-adjustable filter cartridge 300 that may be employed in the exemplary housing system 10 described above with reference to FIG. 1. Specifically, as shown therein, the filter cartridge 300 is generally comprised of a generally cylindrical filter body 312 provided with suitable filter media 314 defining an interior space 316 (see FIG. 8).

A length-adjustable end cap assembly 320 is physically attached to the filter media 314 at the upper end of the cylindrical filter body 316. A bottom end cap 118 may be provided with cartridge 300 in a manner similar to that described above with respect to FIGS. 2-3.

The length-adjustable end cap assembly 320 includes a generally cylindrically configured stationary ring member 324 integrally joined to and extending upwardly from an annular base 326. Most preferably, the stationary ring member 324 and annular base 326 are formed as a unitary (one-piece) structure with one another. Integral cross-support rods 326-1 are provided so as to provide internal support for the base 326, yet allow essentially unimpeded fluid flow therethrough. The ring member 324 is most preferably supported by radially extending buttresses 328 integrally jointed to the ring member 324 and the base member 326.

A moveable connection member 330 is slideably and coaxially received within the stationary ring member 324 and includes a lower cylindrical neck portion 332 and an upper annular support flange portion 334 transversely oriented relative to the central axis of the neck portion 332 (and the filter body 312). An annular elastomeric seal element 334-1 (see FIG. 8) may positioned around the perimetrical edge of the support flange portion 334 so as to enhance its sealing functions. The neck portion 332 includes an annular recess which receives an O-ring seal 332-1 therein so as to provide sliding sealing contact with a facing interior cylindrical surface of the stationary ring member 324. The moveable connection member 330 and the stationary ring member 324 are thus moveable axially relative to one another so that the effective axial length of the filter cartridge 300 may be varied between a lesser axial length (i.e., as shown in solid line in FIG. 8) and a greater axial length (i.e., as shown in phantom line in FIG. 8). As such, the bottom end cap 118 of the filter cartridge 300 can virtually be assured of being supported at the lower end of the rigid perforated basket 10-9 within the housing 10 as has been previously described.

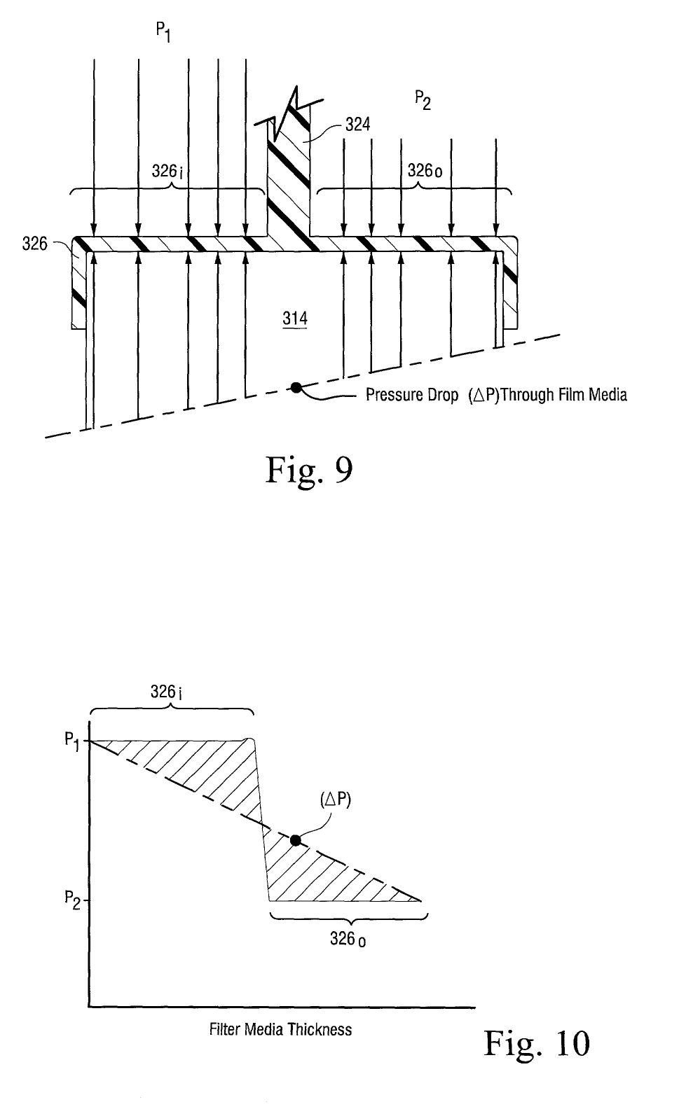

The relative position of the stationary ring member 324 as shown in FIGS. 5-8 provides essentially for a balanced pressure condition (i.e., as between the inlet and discharge fluid pressures P1 and P2, respectively) to be exerted on the annular base member 26. As a result of such a pressure balanced condition, there is less of a tendency for the base member to separate from the filter body 16 (as might tend to occur under relatively extremely high differential pressure (ΔP) conditions between the pressures P1 and P2 of the inlet and discharge fluids, respectively. Such pressure balancing is depicted schematically in FIG. 9 and graphically in FIG. 10.

As is shown in FIG. 9, the inner annular segment 326 of the base member 326 is subjected to a greater pressure condition P1 as compared to the outer annular segment 3260 of the base member 326 due to the pressure drop (ΔP) through the filtration media 314 of the filter body 312. By positioning the stationary ring member 324 substantially midway along the radial dimension of the annular base member 326, therefore, substantially equalized pressure conditions as between the inner and outer annular segments 326ᵢ, 326ₒ, respectively, can be achieved. This attribute of the present invention is shown graphically in FIG. 10 as substantially equal shaded areas between the P1 and P2 pressure conditions and the pressure drop curve ΔP. Since the shaded areas are substantially equal they substantially cancel each other, thereby resulting in an essentially balanced pressure condition to exist. As such, the filter cartridge 300 is especially usefully employed in those applications where relatively extremely high ΔP conditions are required, although it may likewise be used over virtually all other lesser ΔP conditions, if desired.

Most preferably, the moveable connection members 126, 226 and 330 are provided as a component part of the filter cartridges 100, 200 and 300, respectively, when the filter cartridges are supplied to the end user. As such, these connection members 126, 226 and 330 are most preferably made of a plastics material that may be recycled and/or otherwise disposed when the filter cartridge has been spent. However, it is entirely conceivable that the moveable connection members 126, 226 and 330 may be provided as a one-piece reusable component structure formed of a durable material (e.g., stainless steel). When provided as a reusable component, therefore, the connection members 126, 226 and 330 may thus be separated from a spent filter cartridge by the end user and reinserted into a fresh filter cartridge having the other structural components as described previously.

Virtually any filtration media conventionally employed to filter fluids may be employed as the filtration media in the filter cartridges according to the present invention. Thus, for example, the filtration media may be comprised of a non-woven mass of melt-blown polymeric fibers formed, for example, from thermoplastic polymers, preferably polyolefins such as polypropylene, polyethylene and the like. Especially preferred filter media for filter cartridges are those as described more fully in commonly owned U.S. Pat. No. 5,591,335 and U.S. application Ser. No. 09/358,886 filed on Jul. 22, 1999 (now U.S. Pat. No. ______), the entire content of each being expressly incorporated hereinto by reference. Alternatively (or additionally) the filter media may be comprised of pleated sheets of non-woven or woven filter materials which are, in and of themselves, highly conventional in the fluid filtration art.

Therefore, while the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A filter cartridge comprising a generally cylindrical filter body having a fluid-filtration media, and at least one length-adjustable end cap attached to an end of said filter body.

2. The filter cartridge of claim 1, wherein said length-adjustable end cap includes an annular stationary ring member, and a moveable connection member slideably received within said annular stationary ring member so as to be moveable longitudinally relative thereto.

3. The filter cartridge of claim 2, wherein said moveable connection member includes a cylindrical neck portion slideably received within said stationary ring member, and a flange portion at one end of said neck portion.

4. The filter cartridge of claim 2 or 3, wherein said length-adjustable end cap includes an annular base member attached to an end of the cylindrical filter body, and wherein said stationary ring member is generally cylindrical and protrudes upwardly from said annular base member.

5. The filter cartridge of claim 4, wherein said stationary ring member is positioned along a radial dimension of said base member so as to provide for an essentially balanced pressure condition on interior and exterior regions thereof.

6. The filter cartridge of claim 4, wherein said stationary ring member is positioned substantially midway along a radial dimension of the annular base member.

7. The filter cartridge of claim 4, wherein said annular base member includes a cross support rod.

8. The filter cartridge of claim 4, wherein said length-adjustable end cap includes a series of radially extending buttresses joined to said stationary ring member and said annular base member.

9. The filter cartridge of claim 1, further comprising a bottom end cap attached to another end of said filter body opposite said length-adjustable end cap.

10. The filter cartridge of claim 9, wherein said bottom end cap includes an arcuate central wall which protrudes into an interior space of said cylindrical filter body.

11. The filter cartridge of claim 10, wherein said bottom end cap includes a series of integral radial support ribs.

12. The filter cartridge of claim 1, wherein said filter body includes a non-woven mass of melt-blown polymeric fibers.

13. The filter cartridge of claim 1, wherein said filter body includes a pleated fluid filter medium.

14. The filter cartridge of claim 2 or 3, wherein said stationary ring member includes a seal ring in slideable sealing contact with said neck portion of said moveable connection member.

15. The filter cartridge of claim 14, wherein said neck portion includes a stop member which contacts said seal ring and thereby limit movement of said moveable connection member.

16. The filter cartridge of claim 1, wherein said length-adjustable end cap includes a stationary ring member, and a moveable connection member which carries an O-ring seal, and wherein said moveable connection member is slideably received within said stationary ring member such that said O-ring seal is in sliding sealing contact therewith.

17. The filter cartridge of claim 16, wherein said length-adjustable end cap includes an annular base member attached to an end of said filter body, and wherein stationary ring member is generally cylindrical and is integrally joined to, and extends upwardly from, said annular base member.

18. The filter cartridge of claim 17, wherein said moveable connection member includes a cylindrical neck portion slideably received within said stationary ring member in sealing contact with said seal ring, and a flange portion transversely positioned at an uppermost end of said neck portion.

19. The filter cartridge of claim 18, wherein said neck portion includes a recess, and an O-ring seal seated within said recess so as to be in sealing contact with an interior cylindrical surface of said stationary ring member.

20. The filter cartridge of claim 19, wherein said fluid-filtration media includes a non-woven mass of melt-blown polymeric fibers.

21. The filter cartridge of claim 19, wherein the fluid-filtration media includes at least one non-woven or woven pleated sheet of fluid-filtration material.

22. A filter cartridge comprising:
a filter body which defines a generally cylindrical interior space;
a length-adjustable top end cap attached to an upper end of said filter body and defines an opening to allow fluid-communication with said interior space of said filter body;
a bottom end attached to a lower end of said filter body so as to close said interior space thereat; wherein
said length-adjustable top end cap includes:
(i) an annular base member attached to said filter body;
(ii) a generally cylindrical stationary ring member integrally joined at one end to, and extending upwardly from, said annular base member; and
(iii) a moveable member having a generally transverse annular support flange, and a cylindrical neck member integrally depending from said support flange, wherein
(iv) said neck member is slideably received within said stationary ring member so as to move the support flange towards and away from said filter body and thereby establish respective lesser and greater axial dimensions of said filter cartridge.

23. The filter cartridge of claim 22, wherein said stationary ring member is positioned substantially midway along a radial dimension of the annular base member.

24. The filter cartridge of claim 22, wherein said annular base member includes a cross support rod.

25. The filter cartridge of claim 22, wherein said length-adjustable end cap includes a series of radially extending buttresses joined to said stationary ring member and said annular base member.

26. The filter cartridge of claim 22, wherein said bottom end cap includes an arcuate central wall which protrudes into said interior space of said filter body.

27. The filter cartridge of claim 26, wherein said bottom end cap includes a series of integral radial support ribs.

28. The filter cartridge of claim 22, wherein said filter body includes a non-woven mass of melt-blown polymeric fibers.

29. The filter cartridge of claim 22, wherein said filter body includes a pleated fluid filter medium.

30. A filter housing which comprises a rigid basket member having a generally cylindrical side wall, and a filter cartridge as in claim 1 or 22 positioned in said basket member, wherein said length-adjustable end cap allows said filter cartridge to assume a length dimension substantially the same as said side wall of said basket member.

31. A method of installing within an open ended basket of a filter housing a filter cartridge having a generally cylindrical filter body which includes a fluid-filtration media, and at least one length-adjustable end cap attached to an end of said filter body, wherein said method comprises positioning the filter cartridge within the filter housing, and longitudinally moving the length-adjustable end cap thereof until said non-standard size filter cartridge corresponds substantially to an effective lengthwise dimension of said basket.
